(19) United States
(12) Patent Application Publication
(10) Pub. No.: US 2010/0098868 A1
(43) Pub. Date: Apr. 22, 2010

(54) Silicone infused fabric and method

(76) Inventor: Tao-Ming Tom King, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/288,311

(22) Filed: Oct. 16, 2008

(51) Int. Cl. B05D 3/02

(52) U.S. Cl. 427/389.9

(57) ABSTRACT

A method for making coated fabric using a mixture of silicone particles and solvent to infuse the silicone particles into voids between thread fibers forming a woven or knitted fabric material. The fabric is formed using solvent and nano-sized silicone chosen in a size adapted to enter into the voids of the fibers. A controlled amount of coating is applied to one side of the moving fabric allowing it to be rolled up once dried by a blower and cured on the roll.

### BACKGROUND OF THE INVENTION

1. Field of the Invention

The present invention relates to textile manufacturing. More particularly it relates to a silicone infused textile fabric achieved through a simple coating process under a low temperature.

2. Prior Art

Industrial fabrics for use outdoors and in hostile environments have been manufactured for decades. Most such fabrics are especially concerned with tearing-strength, water repellence, water resistence, UV inhibitance, the softness when touched, color fastness or resistance to fade, bacterial growth inhibitance, and other factors that may be affected and imparted to the fabric by the manufacturing process. This process to date has required a plurality of sequential steps for coating application and curing.

A good example of a process and product is taught in U.S. Pat. No. 4,478,895 (Makami). This patent teaches a method of preparing a silicone elastomer coated fabric which yields a final fabric which is elastic and pliable. Manufacturing involves a two step process where first the cloth is coated with an addition-reaction-curing silicone elastomer composition which employs a platinum system catalyst or with an organic peroxide-curing silicone elastomer composition. This uncured elastomer layer is then, in a second step, coated with a silicone resin composition. Once coated, the silicone elastomer composition layer, and the silicone resin composition layer, are then heat-cured simultaneously.

Another example of the conventional multi-step process is shown in U.S. Pat. No. 4,666,765 (Caldwell) which is also directed to a conventional two-step method for making silicone coated woven fabric substrates. The method in Caldwell comprises a first step of applying a first liquid polysilicane elastomer to a fabric substrate so as to form a base coat. This first coating is then cured under high heat. Once the base coat is cured, in a second step, a second liquid polysilicane elastomer is applied over the cured base coat so as to form a top coat. In a subsequent step, this top coat must be cured under high heat to finish the product.

In another example, U.S. Pat. No. 4,725,635 (Okada) discloses a silicone-based fiber finishing agent for use in manufacturing synthetic fiber-made fabric materials such as waddings of polyester fibers. Okada indicates the agent imparts excellent softness and smoothness to the resulting product and resists yellowing even when heated and also has a high resistance against dry cleaning. However, in the method employed by Okada, the fiber finishing agent contains three (3) individual parts and needs to be mixed at a high temperature and cured in a multi-step curing process. The process of Okada is long and requires curing at 150 degrees centigrade for 6 hours and then a subsequent curing at 200 degrees for a duration up to 30 minutes. This high temperature secondary step precludes the use of most synthetic fibers for the base fabric as they will melt at temperatures more than 200 degrees.

U.S. Pat. No. 5,359,735 (Stockwell) teaches a process for coating a fabric surface which includes preparing a coating mixture by mixing a selected solvent with a silicone rubber adhesive sealant. This mixture is then sprayed as a very thin layer to a woven fabric so that the resulting layer has pore spaces corresponding to gaps in the weave of the fabric, so as to provide a semipermeable membrane.

Yet another example of the conventional art in this area is shown in U.S. Pat. No. 5,863,625 (Chiou). Chiou teaches a coating system of silicone rubber. However, using the Chiou process, the only end product produced is not permeable and is only suitable for airbag fabrics or instances where non-permeable fabrics are used.

As can be surmised, this multi-step process of coating and subsequent curing under high heat conditions is costly in energy and labor to produce the resultant fabric. The high temperatures can severely limit the textile fabric employed as the base in the process since most melt at high temperatures. Further, because of the plurality of sequential steps of coating and curing at high heat which must be followed, production rates for fabric are slow and cumbersome.

As such, what is needed is a silicone elastomer coated fabric which can be manufactured more quickly with less energy and less labor and at temperatures which allow for the employment of a wider array of synthetic materials. Such a process should alleviate the multiple high temperature curing steps of conventional manufacturing and instead employ lower temperature processing and simple coating. This will allow a much faster process and also allow larger sections of fabric to be processed in less time which surely will cut costs.

Still further, such a method should provide for permeable or non-permeable fabrics in the finished products giving the manufacturer more options as to the final product from the process.

### SUMMARY OF THE INVENTION

The method and product herein disclosed and described achieves the above-mentioned goals through the provision of a different process, using different coating formulas yielding broader applications than the prior art. The manufacturing process which employs a coating which uses a formula for a compound which is mixable at room temperature. The process requires only one coating to be imparted to the underlying fabric instead of the above-noted conventional two-step coating and curing process. The fabric so produced is manufactured at lower temperatures than the conventional processes noted. The lower temperatures allow for many more synthetic base fabrics to be employed. Further, the lower temperatures and shortened times use less energy and turn out more and longer fabric sections in less time.

Employing the mixture and method herein, the finishing agent may be scraped onto the fabric and will infuse into the pores of the filaments. In a single pass, this yields a fabric that is both an air permeable yet water-pressure resistant product. However, the resulting product can also be made impermeable by repeating the low temperature coating process.

Unlike the prior art, the fabric yielded by the process herein, does not need to be dried before being rolled up. Neither does it need to be heated to cure, which allows the product to be mass produced on a scale heretofore unavailable by the noted conventional processes in the prior art.

Instead of employing larger sized reinforcing filler in the coating applied to one side of the fabric, the method disclosed herein provides for the use of nano sized particles of silicone mixed with a solvent to yield low surface tension which allows for infusion into the voids of the fabric filaments themselves.

Employing the process herein, a novel silicone infused fabric may thus be produced by filling the voids of the threads' filament pores with the mixed silicone compound. The resulting fabric from this filament infusion, not only imparts shrinkage resistance to the resulting fabric, it also imparts stain-resistance, bacteria resistance, and temperature resistance. In addition, the resulting fabric has enhanced color fastness, reduced friction, and substantially increased tearing strength.

In use, the method herein employs a specific solvent allowing the adjustment of surface tension and viscosity of the silicone based compound. Upon applying that compound onto the surface of a fabric, the majority of the silicone based compound will be quickly drawn into the voids in the threads or filaments of the fabric, with very little remaining coating left on the surface of the fabric.

With the majority of the coating absorbed into the fibers and little coating left on the surface, the resulting fabric will not generate bonding between fabric layers while the fabric is rolled up. As such, employing the method and mixture herein, the finished fabric infused with silicone compound can be quickly rolled up and removed from the coating area and allowed to cure while rolled up. This quick removal yields substantially shortened processing times in the production line and also lowers the heating requirements and required energy.

The resulting fabric made from this novel process yields a fabric that is highly adaptable to many different applications and engineering designs. A partial list of these newly added fabric uses from the fabric yielded herein include wind breakers, rain wear, swimming wear, diving wear, bike wear, uniforms and overalls, safety wear, air structure, geo-membranes, portable shelter, tent, awning, tarp and canvas materials for car, aircraft and ship covers. To change the resultant fabric to fit the ultimate use, the processing times and heating requirements in the manufacturing process are adapted to yield the material with the proper characteristics. The process is also adjusted to yield the desired final product depending on the weights of the fabric and the diameter of the yarn forming it.

With respect to the above description of the coated textile product and process, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other methods and systems for carrying out the several purposes of the present disclosed method yielding coated fabric. It is important, therefore, that the claims be regarded as including such equivalent construction and methodology insofar as they do not depart from the spirit and scope of the present invention.

It is an object of this invention to provide a low temperature method for manufacturing silicone elastomer coated fabric.

It is an object of this invention to provide a silicone elastomer coated fabric in which the applied coating is absorbed into the fibers forming the woven or knitted fabric scrim.

It is a further object of the invention to provide such a method which lessens the time required for the coatings to cure and adhere to the fabric scrim and thereby allow faster production of longer fabric sections.

Yet another object of the method herein is the provision of a coating system wherein minimal coating material remains on the surface of the fabric thereby allowing the fabric to be rolled up and cured.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 is a graphic depiction of the application of the silicone elastomer coating to a fabric scrim and scraping to both impregnate the coating into the fibers forming the scrim and to remove excess.

FIG. 2 depicts the heated air directed at the finished coating to dry the exterior and a progression to a roll for stored curing.

FIG. 2a shows a typical twisted thread formed of smaller fibers or smaller twisted threads.

FIG. 3 is a box chart of the steps of the process.

### DETAILED DESCRIPTION OF THE PREFERRED EMBODIMENTS OF THE INVENTION

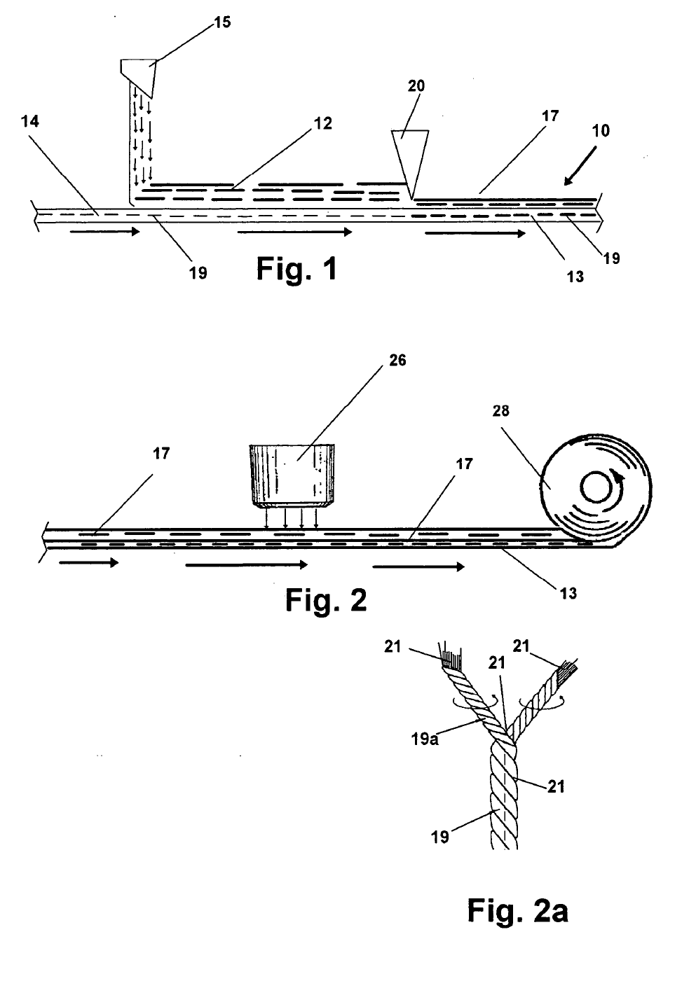

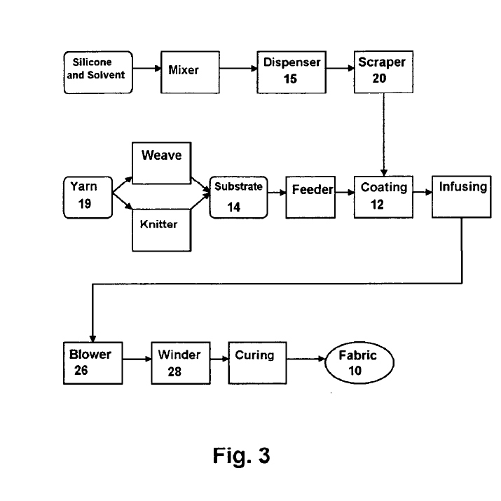

Referring now to the drawings of FIGS. 1-3 for a method and coated fabric material 10 yielded thereby as disclosed herein, wherein similar parts are identified by like reference numerals which may be found in one or more of the drawings. The method herein provides a significant improvement in the production of coated textile fabric material 10 wherein a coating 12 is adhered to a substrate 14.

The resulting fabric material 10 from the method herein employs a textile fabric woven or knitted or otherwise formed to a planar fabric material substrate 14 which may be formed from one or a combination of material fibers 19 from a group of textile fibers including: polyester, acrylic, nylon, acetate, and cotton fiber. The fabric substrate 14 may be formed by weaving, knitting or in a non-woven process such as spun bonding. Of course, any mode of forming the fibers 19 into the fabric material of the substrate 14, as would occur to those skilled in the art, is anticipated in the scope of this invention.

Employing the method of treatment of the formed fabric substrate 14 herein described and disclosed, a much improved silicone infusion process is yielded. This method serves to infuse a majority of the coating 12, directly into the fibers 19 forming the fabric substrate 14 as shown in FIG. 1 wherein the infusion of coating 13 is depicted. A much improved final product is therefor provided over conventional coated fabrics which simply adhere a coating 12 to the exterior of the yarns or fibers 19 forming the fabric substrate 14.

The resulting silicone infused fabric 17 is thereby imparted with the positive characteristics of silicone material coating 12, such as shrinkage-resistance and stain-resistance, increased color fastness, bacteria resistance, reduced friction, temperature resistance, and a substantially enhanced tearing strength.

The coating mixture is premixed depending upon the denier of the fibers 19 formed into the fabric substrate 14. The mixture for the coating 12 is formed of nano-scale silicone and solvent at a ratio of between 40 to 80 percent silicone to solvent by weight depending on the size of the fibers 19 forming the substrate 14. A smaller denier fiber 19 will require more solvent and less silicone by weight to the mixture to allow the silicone to permeate into the smaller voids 21 formed between the individual threads which are twisted or spun or otherwise formed into the fibers 19. The formation of fibers 19 by spinning or twisting smaller threads 19a or fibers is well known through the ages and results in a fiber 19 having air or voids 21 in-between the individual threads making up the fiber. The smaller the denier of the fiber 19 the more solvent is required to carry the nano-particle silicone into the voids 21 between the individual threads forming the fiber 19.

Additionally important to the process and fabric yielded thereby is ascertaining the size of the voids 21 in the chosen substrate 14. As noted smaller fibers 19 will generally have smaller voids 21 which requires silicone particles equal to or less than the size of the voids to allow for the desired infusion of the particles into the voids 21. Nano-scale Silicon Particles are commercially available typically sized 5-25 nanometers (nm) with specific surface area (SSA) in the 30-70 m 2/g range and also available with an average particle size of 80-100 nm range with a specific surface area of approximately 5-10 m 2/g. However, those skilled in the art will realize that other sized nano-scale silicone particles my be employed.

In use, the denier of the fiber 19 is ascertained along with the size of the voids 21 therein. This can be done using industry specification information listing, or by visual inspection of the fibers 19 and voids 21 therein. Once the denier of the fiber 19 and size of the voids 21 are ascertained, and the coating 12 is mixed from the silicone and solvent in a weight of silicone to solvent to allow the infusion of the silicone into the voids 21 in the fibers 19. As noted the preferred mixture varies between 40 to 80 percent silicone to solvent by total weight of the mixture with more silicone for larger denier fibers 19 and less for smaller denier fibers 19 forming the substrate 14.

In choosing the silicone particle size, it should be small enough to flow by surface tension on the threads 19 of the substrate 14 and to thereby initially cover the threads 19 forming the substrate 14 in the warp and the fill and then to sink into the voids 21 in the threads 19 and smaller fibers 19a. Consequently, ascertaining the size of the fibers 19 and voids 21 therein noted above, would provide the necessary information to choose a particle size for the silicone.

In a preferred method to infuse the yarn forming the fabric substrate 14 with the coating 12 or infusion mixture of premixed nano particle silicone and solvent, the steps are as follows:

(a) from a dispenser 15, depositing silicone based compound including nano-sized particle and solvent, such as piethyl siloxane hydroxyterminated, mixed with moisture cured silane amino-organopolysiloxane and ethyl phenyl acetate, to create a low surface tension compound material coating 12 allowing for capillary action into the fibers forming the substrate 14.

(b) Employ a scraper 20 such as a blade, knife, or roller, positioned a distance above said substrate 14 to thereby define a thickness of the silicone based composition deposited onto the fabric substrate 14 and to thereby spread the material coating 12 in an even thin layer over the surface of the fabric substrate 14 while removing any excess of coating 12 exceeding the distance of the knife or roller above the substrate.

(c) allowing the material coating 12 to seep into and infuse voids 21 in the fibers 19 in-between smaller threads 19a and/or smaller fibers 19 twisted to a larger fiber 19 making up the fiber 19 which forms the base fabric substrate 14;

(d) managing the thickness of the coating 12 applied to the fabric substrate 14 in order that the majority of the coating 12 will seep into the fibers forming the fabric substrate 14, and thereby will not be retained on the surface of the fabric substrate 14, whereby the layers of the formed fabric will not stick together after the process when rolled, said managing including:

(i) Employing a heated blower 26 to direct hot air over the coating infused fabric 17 in temperature from 20 degrees to 180 degrees Celsius, to provide a means to remove excess solvents or ethyl phenyl acetates from the infused fabric 17, for a period of no more than 30 minutes;

(ii) Rolling 28 up the infused fabric 17 and allowing a curing process of the infused fabric 17 to occur while on rolls.

(iii) curing the rolled infused fabric 17 at room temperature for a period of 1 to 30 days.

Once the coated and infused fabric 17, is rolled 28, the infused fabric 17 is ready for shipping, handling, and cutting and sewing, as such the curing process can proceed to termination while being shipped or stored.

Alternatively, the application of coating 12 to the desired thickness on the substrate 14 can be handled by including screen printing, spraying, or a gravure method or other methods of depositing a controlled thickness of the coating 12 to the substrate 14 as will occur to those skilled in the art on reading this disclosure. The overriding factor in this application of coating 12 is that a controlled amount and thickness of the coating 12 to the substrate 14 be employed. Currently, the employment of a scraper 20 yields excellent results when the proper mixture of the coating 12 is used and as such is a particularly preferred mode of controlling the amount and thickness of the deposited coating 12.

The infused fabric 17 product manufactured with the above process is permeable and breathable, providing a means for air to still pass through the finished infused fabric 17. Such breathable fabrics could be used in various industrial applications such as garments, textile products, and tarps.

However, in another mode of the method herein, optionally, by repeating the process (a) to (d) as shown above, the resultant infused fabric 17 will become non-permeable due to more coating material 12 occupying pores and such in the fabric substrate 14. Consequently, the process may add these steps to yield non-permeable fabrics for products such as rainwear and air bags.

Finally, in an alternative step to repeating the application process to make a fabric non-permeable, the permeability of the resulting infused fabric 17 may also be adjusted by the step of changing the formula of the silicone based coating 12 composition. Such adjustments are made by changing the composition in the form of adjusting the particle size of the solids of silicone and the concentration of silicone by weight to the solvent such as ethyl phenyl acetate. The mixture of the particles in the coating 12 can vary by weight from 40-80% and the amount of ethyl phenyl acetate by weight may be adjusted between 20 to 60%. Increasing the size of the particles of silicone to a size larger than the voids 21 will cause them to remain on the exterior of the threads 19 and to fill the gaps between individual threads 19 forming the weave or knitted substrate 14.

While all of the fundamental characteristics and features of the method yielding coated fabric have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method for coating fabric formed of engaged fibers and having two surfaces, comprising the steps of:
(a) utilizing silicone based compound including nano sized particle mixed with a solvent, such as piethyl siloxane hydroxyterminated, mixed with moisture cure silane amino-organopolysiloxane and ethyl phenyl acetate, to create a low surface tension composition having a capillary action;
(b) applying said composition onto said fabric in a layer over a said surface of said fabric;
(c) allowing said composition to seep into voids in the fibers forming the fabric;
(d) curing said fabric at room temperature for a period of 1 to 30 days.

2. The method for coating fabric of claim 1 including the additional step of:
(e) rolling up the fabric into rolls and allowing the curing process to occur while rolled on said rolls.

3. The method for coating fabric of claim 1 including the additional step of:
(f) managing a thickness of said layer of said composition applied to said surface of said fabric as a means to infuse a majority of said composition into voids in said fibers forming the fabric to prevent said fabric from sticking together when rolled on said rolls, said managing including the steps of:
(g) Blowing hot air over the fabric in temperature at a temperature between 20 to 180 degrees celsius to provide a means to remove excess solvents or ethyl phenyl acetates for a period of no more than 30 minutes.

4. The method for coating fabric of claim 1 including the additional step of:
(h) rendering said fabric non-permeable by repeating steps (a) to (d).

5. The method for coating fabric of claim 2 including the additional step of:
(h) rendering said fabric non-permeable by repeating steps (a) to (d).

6. The method for coating fabric of claim 1 including the additional step of:
(i) changing the formula of the silicone based compound by one or a combination of: changing the size of said nano sized particles and changing the concentration of ethyl phenyl acetate mixed with said particles.

7. The method for coating fabric of claim 2 including the additional step of:
(i) changing the formula of the silicone based compound by one or a combination of: changing the size of said nano sized particles and changing the concentration of ethyl phenyl acetate mixed with said particles.

8. The method for coating fabric of claim 1 including the additional steps of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

9. The method for coating fabric of claim 2 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

10. The method for coating fabric of claim 3 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

11. The method for coating fabric of claim 4 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

12. The method for coating fabric of claim 5 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

13. The method for coating fabric of claim 6 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

14. The method for coating fabric of claim 7 including the additional step of:
(j) ascertaining a size of said voids in said fibers;
(k) employing said nano sized particles of a particle size smaller than said size of said voids; and
(l) employing a ratio of said nano sized particles to said solvent between 40 to 80 percent nano sized particles to said solvent by weight.

15. The method for coating fabric of claim 13 including the additional step of:
(m) employing said nano sized particles having a said particle size between 5-25 nanometers.

16. The method for coating fabric of claim 14 including the additional step of:
(m) employing said nano sized particles having a said particle size between 5-25 nanometers.

17. The method for coating fabric of claim 13 including the additional step of:
(n) employing said nano sized particles having a said particle size between 80-100 nanometers.

18. The method for coating fabric of claim 14 including the additional step of:
(n) employing said nano sized particles having a said particle size between 80-100 nanometers.

19. The method for coating fabric of claim 10 wherein said managing said thickness of said layer of said composition applied to said surface of said fabric is accomplished by:
moving said fabric;
positioning a scraper a distance above said surface of said fabric on which said coating is deposited while said fabric is moving, whereby said coating is deposited on said fabric in a said thickness substantially equal to said distance of said scraper above said surface of said fabric.

20. The method for coating fabric of claim 18 including the additional step of:
(o) employing said nano sized particles having a said particle size between 5-25 nanometers or 80-100 nanometers.
